(19) United States
(12) Patent Application Publication
(10) Pub. No.: US 2010/0118165 A1
(43) Pub. Date: May 13, 2010

(54) VIDEO SIGNAL PROCESSING APPARATUS

(76) Inventor: MAKOTO SAIJO, KANAGAWA (JP)

Correspondence Address: FROMMER LAWRENCE & HAUG LLP, 745 FIFTH AVENUE, NEW YORK, NY, 10151, US

(21) Appl. No.: 12/611,171

(22) Filed: Nov. 3, 2009

(30) Foreign Application Priority Data
Nov. 4, 2008 (JP) P2008-283630

(51) Int. Cl. H04N 5/262; H04N 5/268

(52) U.S. Cl. 348/240.99; 348/705; 348/E05.057; 348/E05.055

(57) ABSTRACT

A video signal processing apparatus includes: an input section to which a video signal outputted from a camera whose operation is controllable or a video signal outputted from an apparatus whose operation is not controllable; first and second operation sections to which a video switcher function setting the order in which the video signals are put on the air and a camera controller function controlling the operation of the camera are assigned, respectively; a function mode switching section choosing first and second function modes to which the video switcher function and the camera controller function are assigned, respectively; a third operation section performing a predetermined process on the video signals in the first function mode, whereas controlling the operation of the camera in the second function mode; and an output section outputting the video signals to a display device or outputting a control signal controlling the operation of the camera to the camera.

### BACKGROUND OF THE INVENTION

1. Field of the Invention

The present invention relates to a video signal processing apparatus, for example, suitably used to operate a camera while changing the order in which video signals are outputted.

2. Description of the Related Art

A video switcher has been known as an apparatus that relays live video images being captured by a camera and produces content based on the video images captured by the camera. More specifically, a video switcher is an apparatus that receives video signals from a plurality of channels, selects any of the video signals and outputs the selected video signal to a projector or any other destination to which video images are outputted, and exerts wiping and other effects on a video image when the video image is switched to another.

Using a video switcher also readily allows a video image outputted as a current on-air video image (PGM output video image) to be switched to a video image that will be outputted as the next on-air video image (NEXT output video image, which is also referred to as a preview output video image).

The video switcher can also display the PGM output video image and the NEXT output video image, before they are switched, in a multi-view display format on a screen of a display device or any other suitable component that is the destination to which the video images are outputted so that a user can check both the images simultaneously. In the multi-view display format, a screen is divided into a plurality of areas and video images produced from different video signals are displayed in the respective areas. The display format allows the user to look at a PGM output video image being outputted as an on-air video image and align or otherwise adjust a NEXT output video image that is next put on the air.

When a plurality of cameras are used to capture the live video images described above, a camera controller that controls the operation of each of the plurality of cameras is often used as well as a video switcher. A camera controller is an apparatus that remotely performs, for example, iris, focus, and zoom control in each of the cameras connected to the camera controller via cables or any other suitable component.

JP-A-10-150585 discloses a technology in which a camera control unit and a video switcher are used to control the operation of a video camcorder and perform video image processing at the same time.

### SUMMARY OF THE INVENTION

To operate cameras through a camera controller, video images captured by the cameras under control need to be displayed on a display device. It is also necessary to quickly select any of the cameras under control at a necessary timing. To this end, separate video switchers and remote controllers for camera operations have been concurrently used, and each device typically requires a dedicated operator. Further, since the interface terminal of each of the video switchers needs to be connected to that of the corresponding camera controller, related setting operations are time consuming.

In recent years, a video switcher capable of controlling cameras through a single operation panel has been provided. However, when a plurality of functions are assigned to each of a large number of buttons arranged on the operation panel, it is not easy for the user to find which function is assigned to which button, and it is hence difficult for the user to carry out an intended operation in a prompt manner. Further, since a video switcher having a large number of operation buttons has a width of at least several tens of centimeters, the user finds an operation of the video switcher with one hand inconvenient.

Moreover, a video switcher of related art performs the camera control function and the video switcher function separately. Therefore, for example, to switch from the camera control function to the video switcher function, the user needs to terminate the camera control function before performing the video switcher function. As described above, simply integrating a video switcher with a remote controller for camera operations causes wiring to be complicated and typically requires elaborate setting, imposing inconvenience on the user.

Thus, it is desirable to readily switch the function between the camera controller function and the video switcher function.

A video signal processing apparatus according to an embodiment of the invention includes an input section to which a video signal outputted from a camera the operation of which is controllable or a video signal outputted from an apparatus the operation of which is not controllable, and a first operation section to which a video switcher function is assigned, the video switcher function setting the order in which the video signals are put on the air.

The video signal processing apparatus further includes a second operation section to which a camera controller function is assigned, the camera controller function controlling the operation of the camera, and a function mode switching section choosing a first function mode to which the video switcher function is assigned or a second function mode to which the camera controller function is assigned.

The video signal processing apparatus further includes a third operation section performing a predetermined process on any of the video signals in the first function mode, whereas controlling the operation of the camera in the second function mode.

The video signal processing apparatus further includes an output section outputting any of the video signals to a display device displaying an image or outputting a control signal controlling the operation of the camera to the camera.

The configuration described above allows the video switcher function and the camera controller function to be arbitrarily switched and performed.

According to the embodiment of the invention described above, since the video switcher function and the camera controller function can be arbitrarily switched and performed, the operability of the apparatus operated by the user is advantageously improved.

### BRIEF DESCRIPTION OF THE DRAWINGS

FIG. 1 is a schematic diagram showing an exemplary configuration of a system in an embodiment of the invention;

FIG. 2 is a descriptive diagram showing an exemplary configuration of an operation input unit in an embodiment of the invention;

FIG. 3 is a perspective view showing an exemplary external configuration of a joy stick in an embodiment of the invention;

FIG. 4 is a block diagram showing an exemplary internal configuration of a video signal processing apparatus in an embodiment of the invention;

FIG. 5 is a state transition diagram showing exemplary function mode switching in the video signal processing apparatus in an embodiment of the invention;

FIG. 6 is a descriptive diagram showing an example of how a switched function mode is displayed in an embodiment of the invention;

FIG. 7 is a perspective view of the operation input unit in an embodiment of the invention;

FIG. 8 is a plan view of the operation input unit in an embodiment of the invention;

FIG. 9 is a front view of the operation input unit in an embodiment of the invention;

FIG. 10 is a rear view of the operation input unit in an embodiment of the invention;

FIG. 11 is a right side view of the operation input unit in an embodiment of the invention;

FIG. 12 is a left side view of the operation input unit in an embodiment of the invention; and

FIG. 13 is a bottom view of the operation input unit in an embodiment of the invention.

DESCRIPTION OF THE PREFERRED EMBODIMENTS

The best mode for carrying out the invention (hereinafter referred to as an embodiment) will be described below with reference to the accompanying drawings. The description will be made in the following order.

1. Embodiment (an exemplary configuration of a signal processing apparatus with cameral controller and video switcher functions)

2. Variations

### 1. Embodiment

### [Exemplary System Configuration]

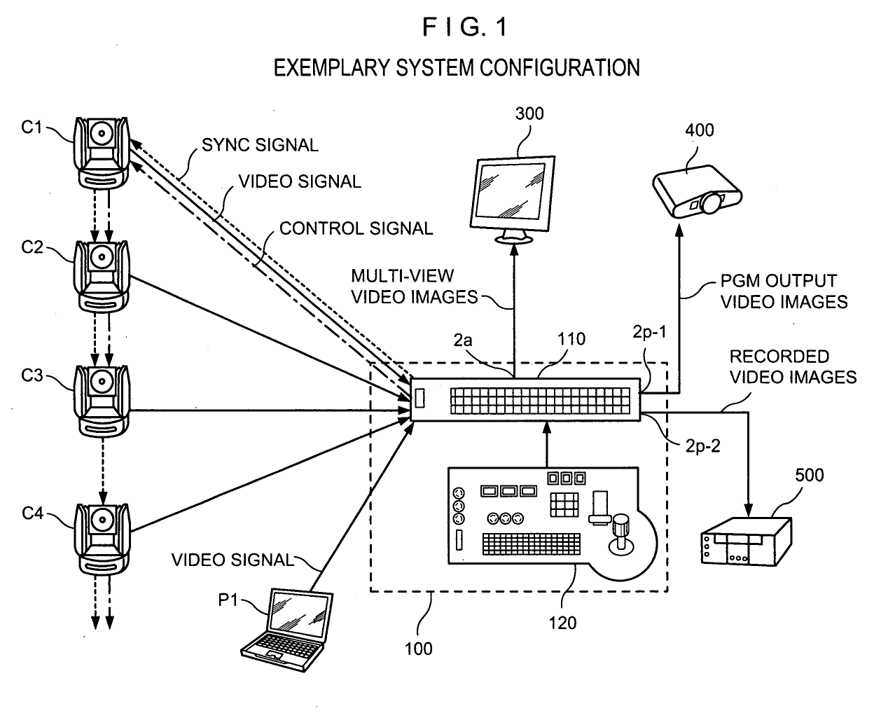

FIG. 1 shows an exemplary configuration of a system according to the present embodiment. The system shown in FIG. 1 includes a video signal processing apparatus 100 having a video switcher function and a camera control function. The video signal processing apparatus 100 is formed of a main unit 110 and an operation input unit 120. While the main unit 110 and the operation input unit 120 are separate units in the present embodiment, they may be integrated with each other.

The video signal processing apparatus 100 is a portable apparatus and used to, for example, relay events that take place in a large lecture hall, a large conference room, a live concert hall, and any other similar place and produce video content that introduces how the events have proceeded.

The main unit 110 shown in FIG. 1 is connected to four cameras C1 to C4 and a personal computer (hereinafter referred to as a PC) P1 as sources from which video images are inputted.

The cameras C1 to C4 are connected to SDI (Serial Digital Interface) input terminals (not shown) or any other suitable terminals of the main unit 110, and video images captured by the cameras C1 to C4 are inputted to the main unit 110 via the respective input terminals. The image capturing operation in the cameras C1 to C4 is synchronized with a sync signal supplied from the main unit 110.

Each of the cameras C1 to C3 is provided with a serial interface based on the VISCA® protocol or any other suitable protocol and connected to the main unit 110 via a serial cable (not shown) for transferring a control signal. That is, the main unit 110 can control the cameras C1 to C3 by supplying control signals (camera control commands) thereto. An ACK message or any other similar response from each of the cameras C1 to C3 is also sent over the corresponding serial cable to the main unit 110.

The camera C4 is connected to the main unit 110 via a DVI (Digital Visual Interface) cable or any other suitable cable, and video images captured by the camera C4 are transferred to the main unit 110 through a DVI input terminal (not shown). The camera C4, which does not have any terminal to which a control signal from the main unit 110 is inputted, is not controllable by the main unit 110.

The PC P1 is connected to another DVI input terminal, an RGB input terminal, or any other suitable terminal (not shown) of the main unit 110 and inputs still images, motion images, or any other images stored in an HDD (Hard Disk Drive, not shown) or any other storage to the main unit 110.

The main unit 110, which has the video switcher function and the camera control function as described above, switches the output video image between a PGM output video image and a NEXT output video image in the video switcher function mode in which the video switcher function is assigned to the main unit 110, whereas the main unit 110 controls the cameras under control in the camera controller mode in which the camera controller function is assigned to the main unit 110. The configuration of the main unit 110 will be described later in detail.

The main unit 110 is connected to a destination to which video images are outputted from the main unit 110, for example, a display device 300 formed of an FPD (Flat Panel Display) or any other suitable component, a projector 400, and a recording device 500 formed of an HDD or any other suitable component. In the example shown in FIG. 1, the projector 400 is connected to a PGM output terminal 2p-1 of the main unit 110, and PGM output video images are outputted to the projector 400. The display device 300 is connected to an AUX output terminal 2a of the main unit 110, and video images arranged in the multi-view display format (hereinafter referred to as multi-view video images) or other images are outputted to the display device 300. The recording device 500 is connected to a PGM output terminal 2p-2 of the main unit 110, and records a video signal outputted from the main unit 110 as recorded video images.

The operation input unit 120 connected to the main unit 110 transmits an operation signal according to an operation performed by a user to a control section, which will be described later, in the main unit 110. For example, instructions to switch video images outputted from the main unit 110 are issued from the operation input unit 120.

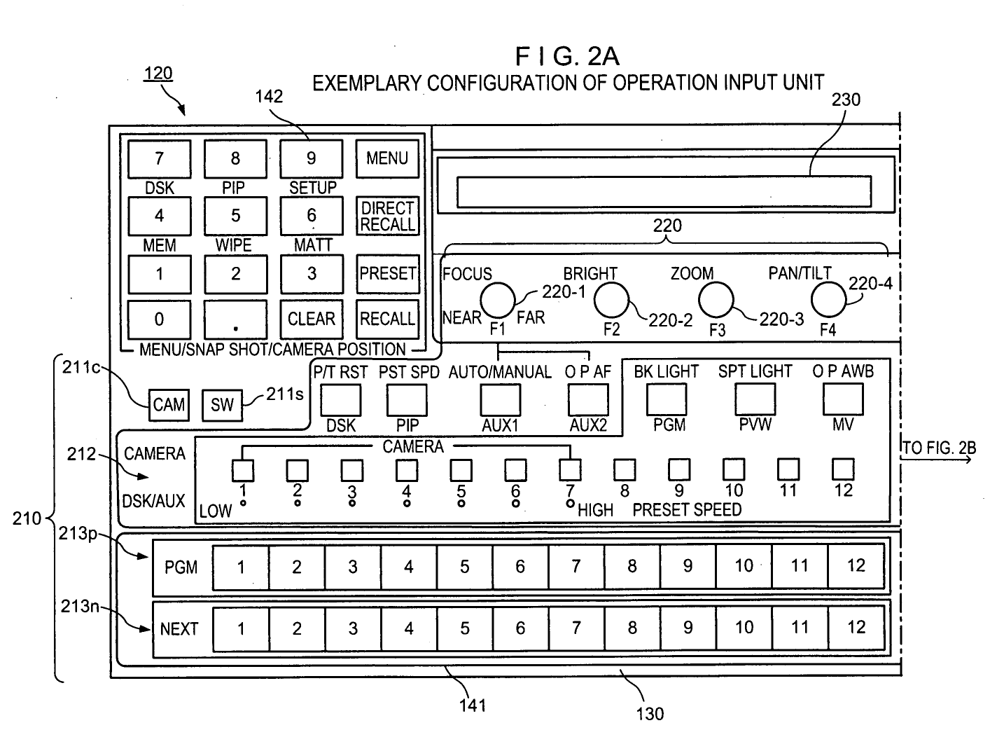

An exemplary configuration of the operation input unit 120 will be described with reference to FIG. 2. The operation input unit 120 shown in FIG. 2 includes an operation button section 210 formed of a variety of buttons, a dial section 220 formed of four dials, and a display section 230.

The operation button section 210 includes a first camera mode switching button 211c and a switcher mode switching button 211s as function selectors, AUX output selection/camera selection buttons 212, PGM selection buttons 213p, and NEXT selection buttons 213n.

The first camera mode switching button 211c switches the mode setting in the main unit 110 from the video switcher function mode to the camera controller mode. The switcher mode switching button 211s switches the mode setting from the camera controller mode to the video switcher function mode. The actual mode switching operation is carried out under the control of the control section 60, which will be described later, when either of the switching buttons is pressed.

In the present embodiment, a second camera mode switching button 214c is disposed to the lower left of a joy stick 240. The first and second camera mode switching buttons 211c and 214c function identically. The first camera mode switching button 211c, the second camera mode switching button 214c, and the switcher mode switching button 211s are hereinafter also collectively referred to as “switching buttons”.

A lamp (an LED, for example) built in each of the switching buttons shows which function mode is enabled. The user can therefore immediately know that the current function mode is the video switcher function mode or the camera controller mode. When the video switcher function mode is chosen, the joy stick 240 is used to position a slave image relative to a master image in a PinP (Picture in Picture). On the other hand, when the camera controller mode is chosen, the joy stick 240 is used to control a selected one of the cameras (perform pan/tilt/zoom control). In this case, the joy stick 240 outputs a first operation signal that instructs the camera to control pan or tilt thereof in accordance with the amount of displacement of the joy stick 240.

The first camera mode switching button 211c is disposed on the left side of an operation panel 130, and the second camera mode switching button 214c is disposed on the right side. In this arrangement, the user can switch to the camera controller mode with either of the right and left hands in the shortest distance. Further, each of the first and second camera mode switching buttons 211c and 214c is disposed in a position close to the center position of the corresponding one of both hands of the user who operates the operation panel 130. Since the user can thus operate the operation panel 130 with both hands, the operability is advantageously improved.

Now, consider a case where the function of the joy stick 240 is assigned to camera pan/tilt/zoom drive operations in the camera controller mode. It is expected in this case that the user presses the second camera mode switching button 214c while holding the joy stick 240. To this end, the second camera mode switching button 214c is disposed in an area spaced apart from the center of the shaft of the joy stick 240 by at least 30 mm but within 100 mm from the center. When the second camera mode switching button 214c is thus disposed, the operability of the apparatus operated by the user is improved. The reason why the second camera mode switching button 214c is positioned in the area described above relative to the joy stick 240 is that the second camera mode switching button 214c positioned too close to the joy stick 240 may cause an operating error.

The AUX output selection/camera selection buttons 212 function as AUX output selection buttons in the video switcher function mode, whereas functioning as camera selection buttons in the camera controller mode. Logical numbers 1 to 12 are assigned to the AUX output selection/camera selection buttons 212. The buttons labeled with 1 to 12 are enabled when the video switcher function mode is chosen, whereas only the buttons labeled with 1 to 7 are enabled when the camera controller mode is chosen. When the video switcher function mode is chosen, the video signal corresponding to the number assigned to the pressed AUX output selection/camera selection button 212 is outputted through the AUX output terminal. On the other hand, when the camera controller function mode is chosen, the video signal inputted from the camera corresponding to the number assigned to the pressed AUX output selection/camera selection button 212 is outputted through the AUX output terminal 2a. It is however possible to set whether or not the AUX output operation is automatically carried out after the camera controller function mode is chosen. The setting operation is carried out in advance by a user's input to a menu mechanism (not shown).

When the AUX output selection/camera selection buttons 212 function as the AUX output selection buttons, and any of the selection buttons is pressed, a video signal inputted through the input port related in advance to the logical number assigned to the pressed button is outputted to the AUX output terminal 2a. In the example shown in FIG. 1, since the display device 300 is connected to the AUX output terminal 2a, video images inputted through the input port related to the logical number described above are displayed on the screen of the display device 300.

When the AUX output selection/camera selection buttons 212 function as the camera selection buttons, video images inputted from the camera under control that is related in advance to the logical number selected by a button pressing operation are outputted through the AUX output terminal 2a. The video images captured by the selected camera under control and outputted through the AUX output terminal 2a are displayed on the screen of the display device 300. The AUX output terminal 2a outputs the video signal to the display device 300 after the video signal undergoes predetermined processing determined by a first operation section 141 and a third operation section 143, which will be described later. The selected one of the cameras C1 to C3 under control can be operated, for example, by using the joy stick 240.

The PGM selection buttons 213p determine which one of the video signals inputted from the cameras C1 to C4, the PC P1, and any other apparatus connected to the main unit 110 is selected as the PGM output. The NEXT selection buttons 213n determine which one of the video signals inputted to the main unit 110 is selected as the NEXT output.

The same logical numbers 1 to 12 as those assigned to the AUX output selection/camera selection buttons 212 are also assigned to the PGM selection buttons 213p and the NEXT selection buttons 213n. For example, when any of the PGM selection buttons 213p is pressed, the video signal inputted through the input port related in advance to the logical number selected by the button pressing operation is selected as the PGM output. The PGM selection buttons 213p and the NEXT selection buttons 213n are designed to function as a video switcher irrespective of whether the video switcher function mode or the camera controller mode is chosen. The video switcher function, which sets the order in which a plurality of video signals are put on the air, is thus assigned to the first operation section 141. In the present example, the first operation section 141 includes the PGM selection buttons 213p, which are used to select a first video signal output to be put on the air from a plurality of inputted video signals, and the NEXT selection buttons 213n, which are used to select a second video signal output to be put on the air after the first video signal. A second operation section 142 to which the camera controller function for controlling the operation of the selected camera is assigned is used, for example, to display a camera menu for operating the camera and make an initial setting of the camera.

The logical numbers are also related to the positions where video images are displayed on the multi-view display screen. The relating operation allows the logical numbers 1 to 12 assigned to the PGM selection buttons 213p or the NEXT selection buttons 213n, the camera numbers, and the display positions on the multi-view display screen to be related to each other in a one-to-one relationship. The relating operation is carried out in advance by the user.

The dial section 220 is formed of four dials, a dial 220-1 to a dial 220-4. When the camera controller mode is chosen, the dial 220-1 functions as a dial for adjusting the focus of any of the cameras under control. The dial 220-2 functions as a dial for adjusting the brightness. The dial 220-3 functions as a dial for adjusting the zoom. The dial 220-4 functions as a dial for adjusting the pan and tilt.

When the video switcher function mode is chosen, the dials 220-1 to 220-4 function as dials for adjusting the functions assigned to functions F1 to F4. The operation input unit 120 further includes the third operation section 143 that performs predetermined processing on a video signal when the video switcher function mode is chosen, whereas controlling the operation of any of the cameras C1 to C3 when the camera controller function mode is chosen. The third operation section includes a plurality of operation buttons labeled with respective numbers. The third operation section 143 includes the AUX output selection/camera selection buttons 212, the dial section 220, and the joy stick 240. The first to third operation sections 141 to 143 and a plurality of switching buttons are thus disposed on the operation panel 130.

The display section 230 is formed of a VFD (Vacuum Fluorescent Display) or any other suitable component and displays the setting of an effect exerted on a video image when the video image is switched to another, a setting menu used to set the cameras under control, and other items.

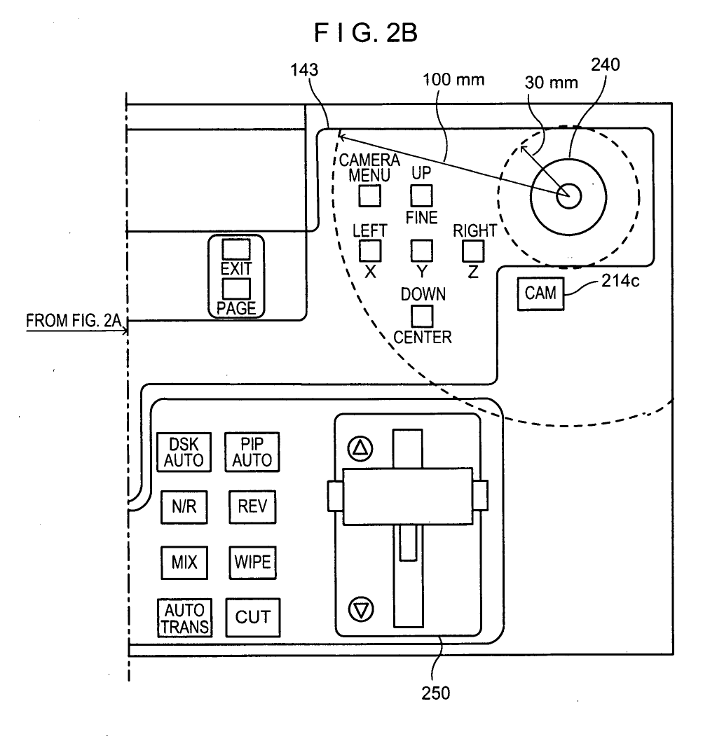

The joy stick 240 is formed of a lever 241 supported pivotally in X-axis, Y-axis and Z-axis directions and a knob 242 provided on the upper end of the lever 241 (See FIG. 3, which will be described later). When the camera controller mode is chosen, the amounts of pan, tilt, and zoom control of any of the connected cameras can be specified by inclining the lever 241 or rotating the knob 242. When the video switcher function mode is chosen, the on-screen position of a PinP inserted in a PGM output video image can be determined by inclining the lever 241.

The transition lever 250 is an operation member shiftable in the up/down direction, and continuously changes a video image to another in accordance with the amount of shift in the up/down direction. The transition lever 250 is also designed to operate in the same manner (operate as a video switcher) irrespective of whether the video switcher function mode or the camera controller mode is chosen.

As described above, operating a relevant one of the switching buttons disposed on the operation panel 130 allows the function mode to be switched appropriately. In the present embodiment, the transition lever 250, an input cross point section 20 to which video signals are inputted, and an output cross point section 40 from which a video signal is outputted are designed to be always operable. Video switching is therefore possible even when any camera control is being performed. On the other hand, the transition lever 250, the first camera mode switching button 211c, and the switcher mode switching button 211s only perform the respective dedicated functions assigned thereto. Therefore, even when the video signal processing apparatus 100 is operated in the camera controller mode, the main video image can be switched to another.

The third operation section 143 performs a certain function in the camera controller mode and another function in the video switcher function mode. For example, a plurality of functions according to function modes to be selected are assigned to each of the AUX output selection/camera selection buttons 212 and the joy stick 240. As a result, the number of switches, buttons, and other components can be reduced and hence the area of the operation panel 130 can be reduced, but the user can still switch a video image to another while performing any camera control. Further, the production cost of the video signal processing apparatus 100 and the operation input unit 120 can be lowered.

When the first camera mode switching button 211c is pressed, the video output is also switched in response thereto. In this process, when a camera on which the user wants to perform camera control is specified, a video signal inputted from the camera that has been related in advance is outputted through the AUX output. Further, the menu displayed on the display section 230 can be used to enable or disable the action of switching the video output in response to the operation of the first camera mode switching button 211c.

In the video signal processing apparatus 100 of the present example, the camera numbers (camera IDs) and the input source numbers (terminals) are related to each other in advance. When an input source number to which video images captured by the camera that the user wants to control are inputted is selected on the apparatus side, the video signal produced by the camera that the user wants to control can be outputted through the AUX output. Therefore, when a camera that the user wants to control is selected, the video signal outputted from the camera can be displayed on the display device 300. For example, when the user wants to “operate the camera C3” and presses the “third” AUX output selection/camera selection button 212 corresponding to the camera C3, video images outputted from the camera C3 are displayed on the display device 300. This enhances the convenience to the user because pressing an AUX output selection/camera selection button 212 readily provides the corresponding video output.

As described above, the operation input unit 120 allows the user to control both the video switcher function and the camera control function by pressing a relevant one of the operation buttons disposed on the single operation panel 130. Further, the joy stick 240, which has been used in a video switcher of related art to position a PinP (Picture in Picture), is also used to perform camera control (pan/tilt/zoom). Moreover, the video signal processing apparatus 100 allows the user to operate a single camera arbitrarily selected from a plurality of controllable cameras equipped with a PTZ (pan/tilt/zoom) function. Any operation of the cameras that have not been selected is disabled so that no camera control is performed. In this case, no camera control command can be transmitted to the cameras that have not been selected, or the cameras that have not been selected are not allowed to receive a camera control command. It is however noted that only the operations using the video signal processing apparatus 100 are disabled, but a remote controller or any other suitable device (not shown) can be used to operate any of the cameras that have not been selected.

When the first camera mode switching button 211c is pressed, the mode of the apparatus transitions to the camera controller mode. When the user presses a key, a control command corresponding to the pressed key is issued to the selected one of the cameras C1 to C3. Specifically, the control command is transmitted to the selected one of the cameras C1 to C3 via RS-232C or RS-422, and the camera receives the control command. Further, incorporating a network terminal or any other suitable component in the video signal processing apparatus 100 allows the user to operate any of the cameras C1 to C3 by using a communication protocol different from the communication protocol used to transmit the control command described above.

When the video switcher function and the camera control function are integrated in related art, function switching is also used to reduce the number of buttons as much as possible. In contrast, part of the video switcher function is assigned to buttons operable irrespective of which function mode is chosen. In this way, the user can switch a video image to another while performing camera control, although the number of operation buttons on the operation panel 130 is increased. For example, the PGM selection buttons 213p and the NEXT selection buttons 213n perform only the video switcher function also in the camera controller mode. The user can therefore operate any of the cameras C1 to C3 and perform video switching at the same time. The user can therefore switch a video output to another while operating any of the cameras.

The joy stick 240 is more frequently used to control pan/tilt/zoom in the camera control function than used to position a PinP. To this end, only the second camera mode switching button 214c may be disposed in the vicinity of the joy stick 240 so that the mode of the apparatus can be readily switched to the camera controller mode.

An exemplary external configuration of the joy stick 240 will be described with reference to FIG. 3.

First, assume an xy plane parallel to the operation panel 130. The joy stick 240 includes the lever 241, which issues an instruction, for example, for movement in an arbitrary direction when the lever 241 is inclined to the xy plane by a predetermined angle, and the knob 242, which performs zoom or other control in any of the cameras C1 to C3 when the knob 242 is rotated. The joy stick 240 further includes a fulcrum 243 that connects the lever 241 to the operation panel 130 and works as a fulcrum for the lever 241. The knob 242 issues a control signal according to the angle of rotation, and the control section 60 reads the control signal and performs zoom control in the selected camera. The relationship between the rotating direction and the zooming direction can be set by a user's operation of the setting menu (not shown) in advance.

The knob 242 is rotatable around the center of the lever 241 in the y direction within a range from +30 degrees to −30 degrees, and the angle of rotation of the knob 242 is related to the zoom function, which is one of the camera control functions. For example, when the knob 242 is rotated clockwise, the zoom factor of the selected camera is changed toward the telescopic side, whereas when the knob 242 is rotated counterclockwise, the zoom factor of the selected camera is changed toward the wide-angle side. The relationship between the direction in which the knob 242 is rotated and the zooming direction described above may be reversed. The user can arbitrarily set the relationship.

The direction in which the lever 241 is inclined is defined as follows: The x direction is assigned to the pan direction, and the y direction is assigned to the tilt direction. The pan and tilt directions are also defined arbitrarily in accordance with user's preference, as in the zooming direction.

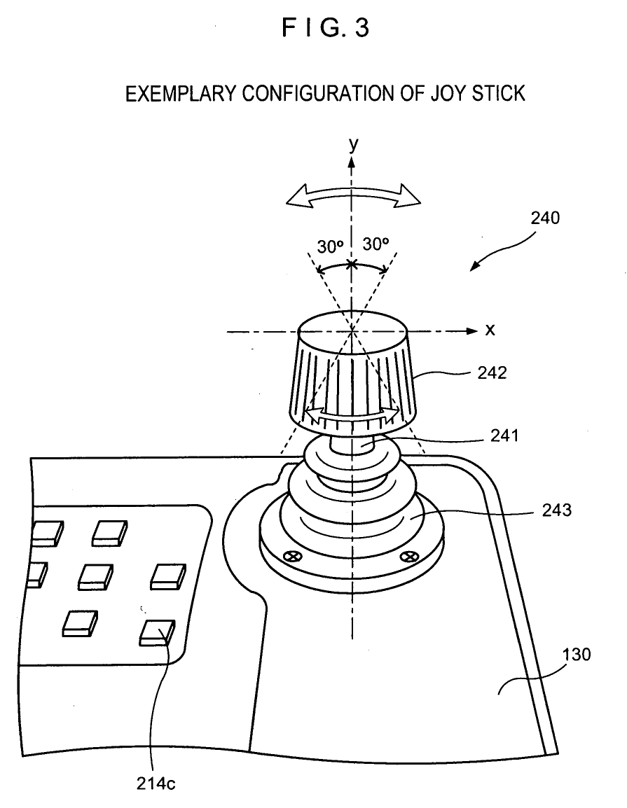

An exemplary internal configuration of the main unit 110 will be described with reference to FIG. 4. In FIG. 4, the portions corresponding to those in FIGS. 1 and 2 have the same reference characters. The main unit 110 includes an SDI interface (hereinafter referred to as an I/F) 10-1 to an SDI I/F 10-4 and an optional card I/F 15 as input sections. The SDI I/F 10-1 to SDI I/F 10-4 include four respective SDI input terminals 1s-1 to 1s-4, to each of which an HD-SDI or SD-SDI signal is inputted. According to the configuration shown in FIG. 1, the video signals outputted from the cameras C1 to C4 are inputted to the SDI I/F 10-1 to SDI I/F 10-4. The video signals outputted from cameras the operation of each of which is controllable are inputted to the SDI input terminals 1s-1 to 1s-3. The video signal outputted from an apparatus the operation of which is not controllable is inputted to the SDI input terminal 1s-4.

Each of the SDI I/F 10-1 to SDI I/F 10-4 includes an equalizer (EQ) 11, a serial/parallel converter (S/P) 12, a frame synchronizer (FS) 13, and an amplifier (AMP) 14.

The equalizer 11 shapes the waveform of an inputted HD/SD-SDI signal and supplies the signal having undergone the waveform shaping to the serial/parallel converter 12. The serial/parallel converter 12 converts the HD/SD-SDI serial signal supplied from the equalizer 11 into a parallel signal and outputs it to the frame synchronizer 13. The frame synchronizer 13 supplies the inputted parallel video signal to the amplifier 14 in synchronization with a reference sync signal in the main unit 110. The amplifier 14 amplifies the inputted video signal to an appropriate magnitude and supplies the amplified signal to the input cross point section 20 as an input selector.

The optional card I/F 15 is an I/F into which an optional card is inserted. An optional card is a card that is not assembled at the time of factory shipment but adds a function that is not implemented as a standard function. A variety of optional cards are available, such as a card with an analog video signal input terminal, a card with a DVI input terminal, and a card with an HD/SD-SDI input terminal. In the main unit 110 according to the present embodiment, any two of the cards described above at the maximum can be connected to the optional card I/F 15. Therefore, a plurality of video signal terminals are present on the optional card I/F 15. FIG. 4 however collectively shows these terminals in the form of an input video terminal lo to simplify the description.

In the configuration shown in FIG. 1, the optional card I/F 15 receives a video signal from the PC P1 connected to the terminal of an optional card inserted into the optional card I/F 15. Processing operations according to the type of the assembled card are carried out in the optional card I/F 15, which then outputs the processed video signal to the input cross point section 20. The type of the inputted signal is not limited to those described above, but cards with other types of input terminals may be assembled.

The input cross point section 20 selects only the video signal selected by the user through an input video image selection operation performed on the operation input unit 120 among a plurality of video signals supplied through the SDI I/F 10-1 to SDI I/F 10-4 and the optional card I/F 15, and outputs the selected video signal. For example, when the first PGM selection button 213p on the operation input unit 120 is pressed, the input cross point section 20 selects the video signal inputted through the input port related to the logical number 1 as the PGM output. That is, the input cross point section 20 relates the inputted video image to any of the NEXT output, the AUX output, the PinP output, the multi-view output, and any other suitable output and then outputs the video image.

When the video signal selected by the input cross point section 20 needs to be processed, for example, when an effect needs to be exerted on the selected video signal, the video signal is supplied to a switcher/effecter 30 as a screen producer. The switcher/effecter 30, for example, selects an input video image and exerts an effect on a video signal.

The switcher/effecter 30 also produces a frame for displaying a PinP image and frames used in the multi-view display format. When frames used in the multi-view display format are produced, the frame for displaying a PGM output video image, the frame for displaying a NEXT output video image, and the frame for displaying a video image captured by the cameras under control are produced in such a way that the colors of the frames differ from one another. Processes performed in the switcher/effecter 30 are controlled based on a control signal produced in a control section 60, which will be described later, based on an input video image selection operation performed on the operation input unit 120.

The video signal processed in the switcher/effecter 30, for example, the video signal on which an effect has been exerted, and selected as the PGM output is supplied to a parallel/serial converter 51p disposed downstream of the switcher/effecter 30. The parallel/serial converter 51p converts the video signal into a serial video signal and outputs it to a buffer 52p. The video signal inputted to the buffer 52p is converted into a signal appropriate for an output operation and then outputted as the PGM output.

The video signal processed in the switcher/effecter 30, for example, the video signal on which an effect has been exerted, is also supplied to the output cross point section 40 along with the frame information and other information produced in the switcher/effecter 30. The output cross point section 40 also receives a video signal selected by the input cross point section 20 as a video signal on which no effect needs to be exerted.

The output cross point section 40 chooses either the AUX output terminal 2a or a DVI output terminal 2d as an output section to which the video signal supplied from the input cross point section 20 and the video signal supplied from the switcher/effecter 30 are outputted. Choosing either the AUX output terminal 2a or the DVI output terminal 2d as the output section is determined based on a control signal produced in the control section 60 based on an input video image selection operation performed on the operation input unit 120.

The video signal selected by the output cross point section 40 as the video signal to be outputted to the AUX output terminal 2a is supplied to a parallel/serial converter 51a disposed downstream of the output cross point section 40 and converted into a serial video signal. The converted serial video signal is supplied to a buffer 52a, where the signal is converted into a signal appropriate for an output operation and then outputted to the AUX output terminal 2a as the AUX output. While the configuration in the present embodiment has only one AUX output terminal, a plurality of AUX output terminals may be provided.

The video signal selected as the video signal to be outputted to the DVI output terminal 2d is supplied to an I/P (Interlace/Progressive) conversion/resizing processor 51d, where the video signal is converted into an interlaced or progressive video signal and the screen size is changed as necessary. The video signal having undergone the adjustment operations described above is outputted to a buffer 52d, where the video signal is converted into a signal appropriate for an output operation and outputted to the DVI output terminal 2d as the DVI output.

The control section 60 is formed of a CPU (Central Processing Unit) and other components and produces control signals for controlling the portions in the apparatus and camera control commands for controlling the cameras under control based on a variety of types of information inputted through the operation input unit 120.

The control section 60 includes a positional information producer 61, a control signal producer 62, and a serial I/F 63. The control section 60 is connected to a memory 70 formed of an EEPROM (Electrically Erasable Programmable Read Only Memory) or any other suitable component.

The positional information producer 61 in the control section 60 receives information on the operation angle inputted from the joy stick 240 on the operation input unit 120 and information indicating on/off of each of the operation buttons that form the operation input unit 120. The positional information producer 61 produces information indicating the position of any of the cameras under control, that is, information indicating the amounts of pan/tilt/zoom control, based on the information on the inputted operation angle of the joy stick 240, and supplies the produced positional information to the control signal producer 62 disposed downstream of the positional information producer 61.

The control signal producer 62 produces a camera control command based on the information on the operation angle inputted from the joy stick 240 on the operation input unit 120 and the information on tables recorded in the memory 70. The control signal producer 62 also produces control signals for controlling the portions in the main unit 110 based on the operation button on/off information inputted through the operation button section 210 and the information contained the tables recorded in the memory 70.

The control signal producer 62 refers to the tables described above to determine an object to be controlled, produces a control signal directed to the thus determined object to be controlled based on an operation inputted through the operation input unit 120, and supplies the control signal to the object to be controlled. Specifically, the camera control command produced by the control signal producer 62 is transferred to the serial I/F 63 disposed downstream of the control signal producer 62 and converted into a serial signal by the serial I/F 63. The camera control command converted into the serial signal is outputted to a control signal output terminal 2c via a serial driver 80 and transferred to any of the cameras under control via the control signal output terminal. That is, the second operation section 142 and the third operation section 143 are used to output a control signal for controlling the operation of any of the cameras C1 to C3 through the control signal output terminal 2c to the selected one of the cameras C1 to C3 when the camera controller function mode is chosen.

As described above, in the video signal processing apparatus 100, the video switcher function and the camera control function are integrated, and the communication between the two functions is carried out in the video signal processing apparatus 100. The two functions are not simply integrated, but selecting a camera to be controlled after the video switcher function mode or the camera controller mode is chosen causes output video images from the selected camera to be selected.

To perform camera control in a video switcher of related art, it is necessary to operate a switcher device to display the primary output or the standby output in an actual camera control operation. The video signal processing apparatus 100 of the present example, however, automatically outputs a video signal of interest through the AUX output terminal 2a. Therefore, the PGM output video image or the NEXT output video image is not affected.

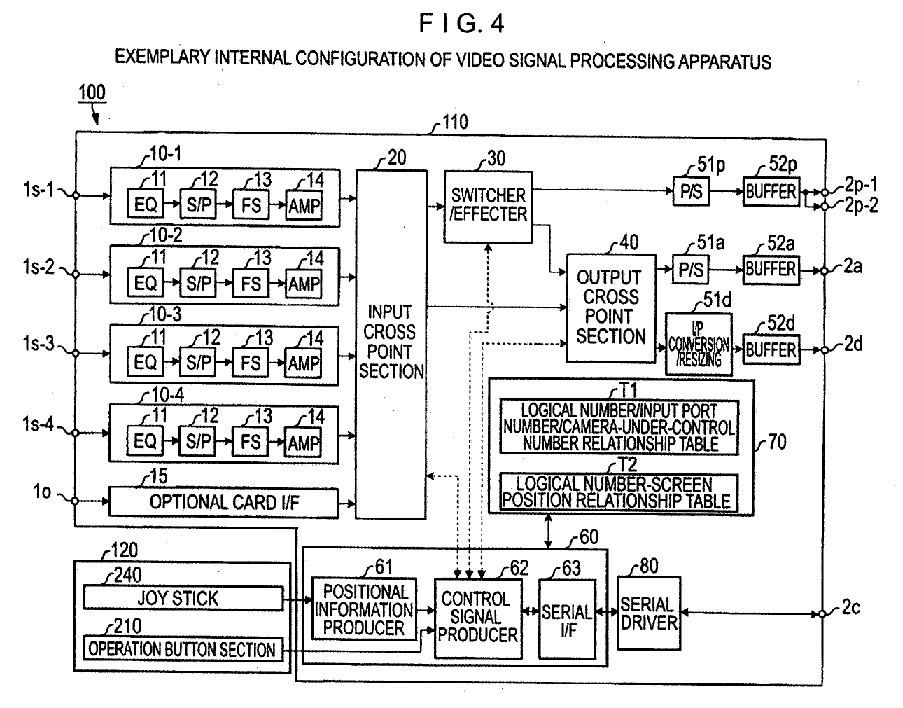

FIG. 5 is an exemplary state transition diagram showing function mode switching in the main unit 110.

In FIG. 5, the state in which the main unit 110 is operated in the video switcher function mode is called a first function mode 261, and the state in which the main unit 110 is operated in the camera controller mode is called a second function mode 262. When the current function mode is the video switcher function mode, and the first camera mode switching button 211c or the second camera mode switching button 214c is pressed, the first function mode 261 is switched to the second function mode 262, and the current function mode is changed to the camera controller mode. On the other hand, when the current function mode is the camera controller mode, and the switcher mode switching button 211s is pressed, the second function mode 262 is switched to the first function mode 261, and the current function mode is changed to the video switcher function mode. As described above, pressing a switching button triggers the switching between the first function mode 261 and the second function mode 262.

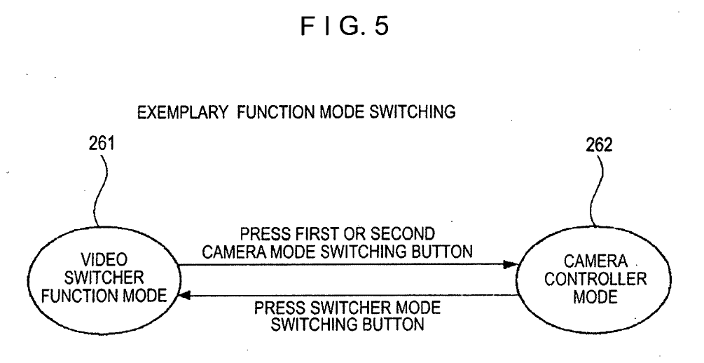

FIG. 6 shows an example of how a switched function mode is displayed.

In the present example, it is assumed that the main unit 110 is operated in the video switcher function mode. In this case, the display section 230 displays the current function mode (video switcher function mode). At the same time, the LED built in the switcher mode switching button 211s lights up, whereas the LEDs built in the first camera mode switching button 211c or the second camera mode switching button 214c do not light up. In this way, the user can see that the main unit 110 is operated in the video switcher function mode.

On the other hand, when the main unit 110 is operated in the camera controller mode, the display section 230 displays the current function mode (camera controller mode, not shown). At the same time, the LEDs built in the first camera mode switching button 211c and the second camera mode switching button 214c light up (not shown), whereas the LED built in the switcher mode switching button 211s does not light up. In this way, the user can see that the main unit 110 is operated in the camera controller mode.

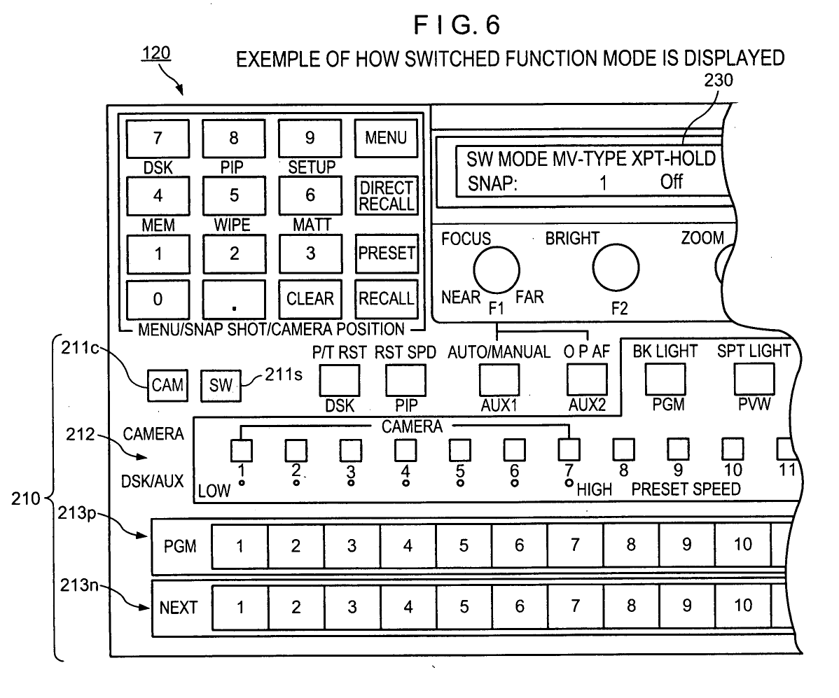

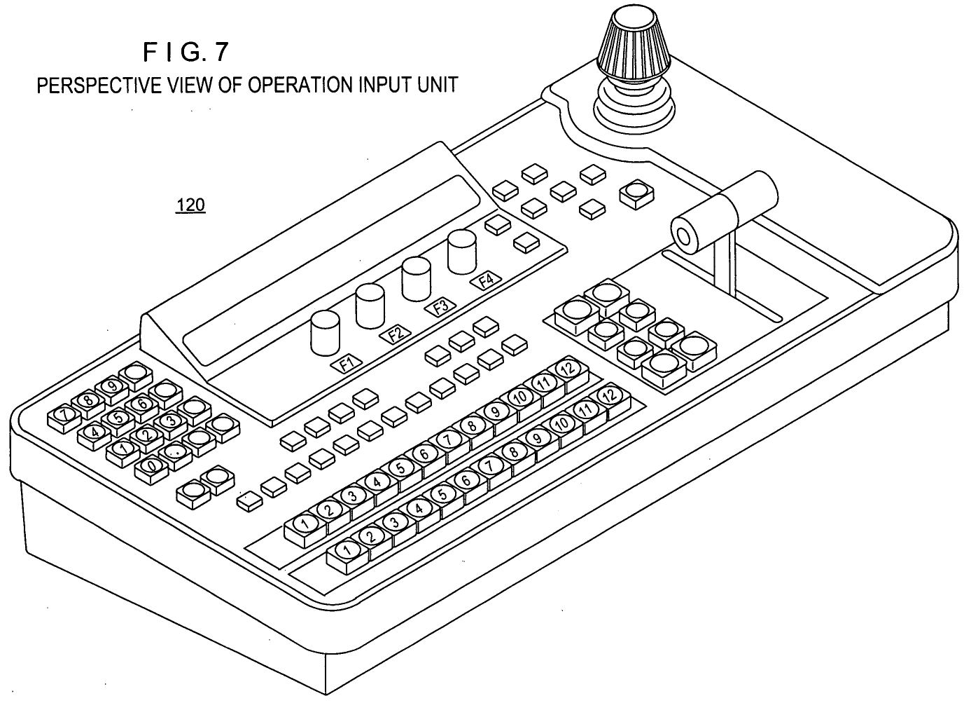

FIG. 7 is a perspective view showing an exemplary specific configuration of the operation input unit 120. FIGS. 8 to 13 show the exemplary specific configuration of the operation input unit 120 viewed in six directions. FIGS. 8 to 13 are drawn in the same scale.

FIG. 7 is a perspective view of the operation input unit 120.

FIG. 8 is a plan view of the operation input unit 120.

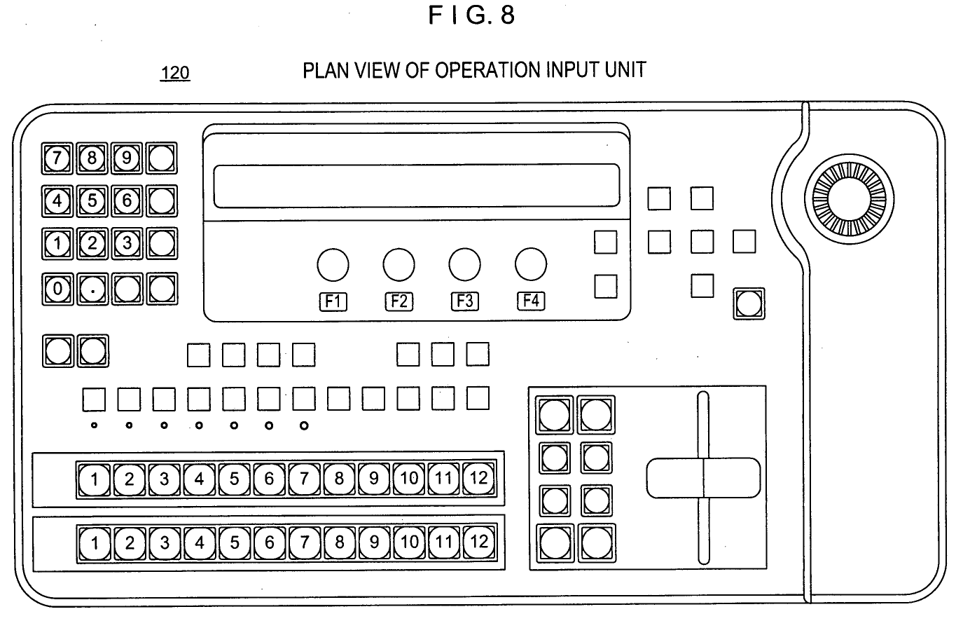

FIG. 9 is a front view of the operation input unit 120.

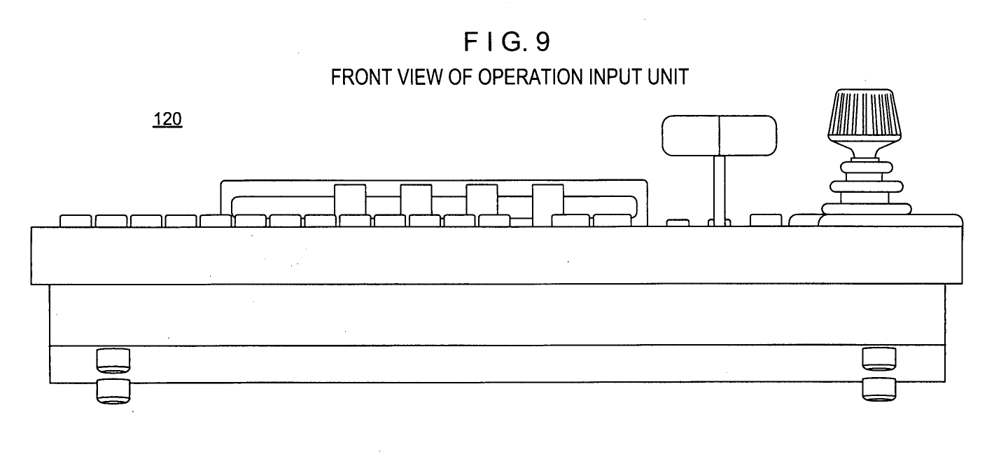

FIG. 10 is a rear view of the operation input unit 120.

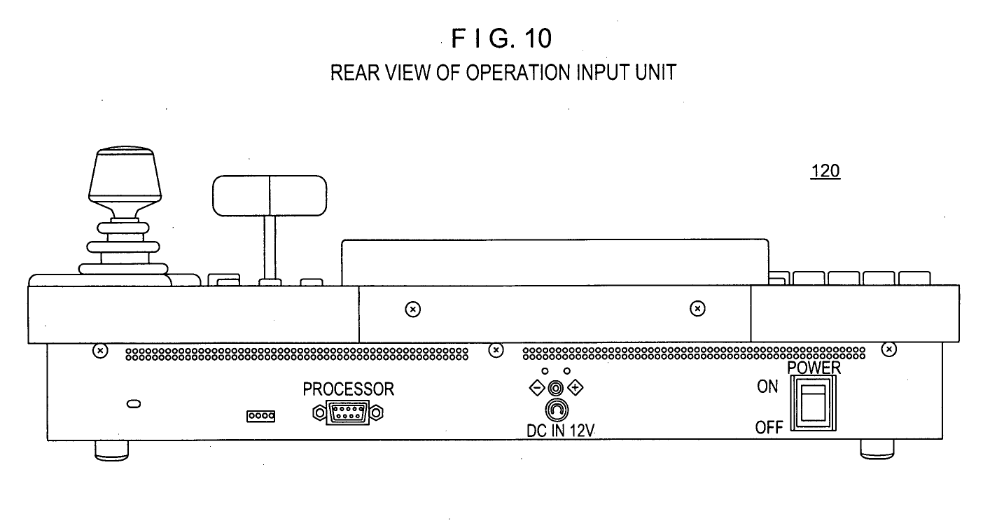

FIG. 11 is a right side view of the operation input unit 120.

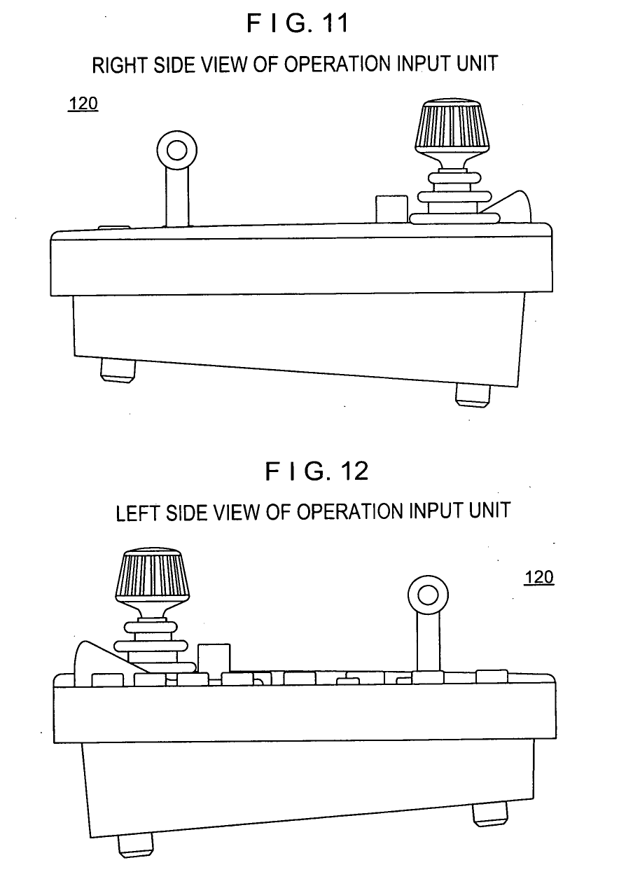

FIG. 12 is a left side view of the operation input unit 120.

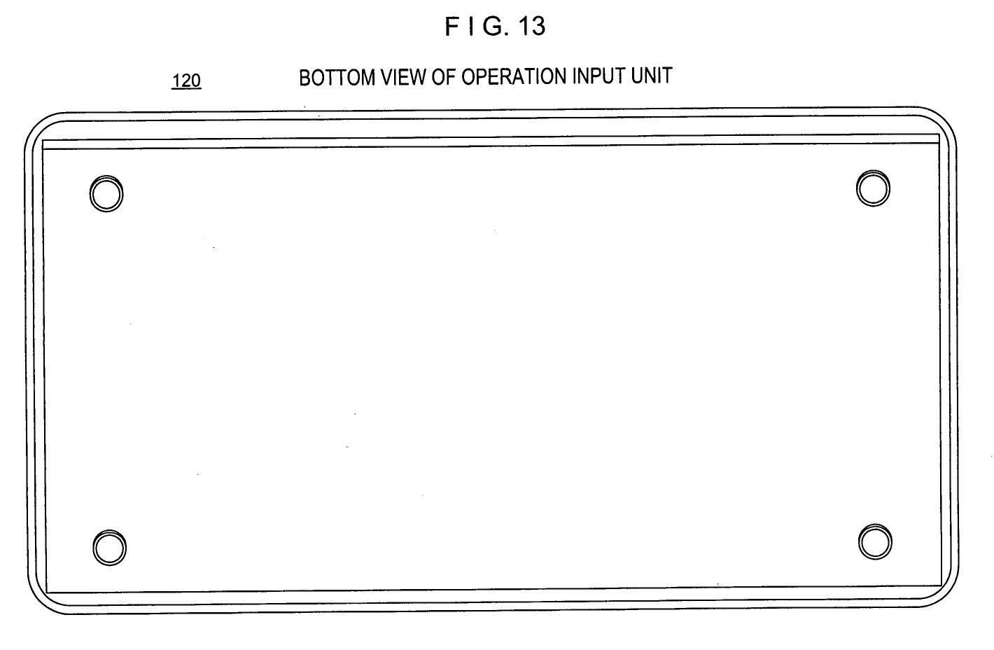

FIG. 13 is a bottom view of the operation input unit 120.

According to the present embodiment described above, a single apparatus concurrently offers two function modes, the video switcher function mode and the camera controller mode. The function of the joy stick 240 is used to control a camera (pan/tilt/zoom) in the camera controller mode, whereas used to position a PinP in the video switcher function mode. Employing the joy stick 240, which has been well accepted as a user interface, allows the user to operate the apparatus in a straightforward, user-friendly manner.

Either of the video switcher function or the camera control function is chosen by operating a relevant one of the plurality of switching buttons arranged on the operation panel 130. The action of the third operation section 143 depends on which function mode is chosen. It is however noted that the video switcher function is always assigned to the first operation section 141. That is, the PGM selection buttons 213p and the NEXT selection buttons 213n are only used to perform the video switcher function, and the camera controller function is not intentionally assigned to the PGM selection buttons 213p or the NEXT selection buttons 213n. In this way, camera operations and video switching operations can be concurrently performed, and the user can perform a video switching operation by which a video signal being put on the air is switched to another while a camera operation is performed.

In the camera controller mode, the user sets in advance the relationship between the input numbers on the operation panel 130 and the camera numbers assigned for management purposes. In this way, the video signal outputted through the AUX output terminal 2a may or may not be automatically displayed. When the video signal is set to be automatically displayed, and a button labeled with a certain management number on the operation panel 130 is pressed, the camera corresponding to the management number becomes operable, and the video signal inputted through the input port corresponding to the management number is outputted through the AUX output terminal 2a. Therefore, camera operations and video switching operations are advantageously readily carried out.

Further, packaging the functions provides an advantage of reduction in size of the video signal processing apparatus 100 and the operation input unit 120. Moreover, the number of parts can be reduced, advantageously resulting in cost reduction.

The second camera mode switching button 214c is disposed not too close to but not too far from the joy stick 240 (at least 30 mm spaced apart from the joy stick 240 but within 100 mm). In this way, the user can switch the function mode with the shortest movement by using either of the camera mode switching buttons disposed on the right and left sides of the operation panel 130 to carry out an intended operation.

### 2. Variations

While the switching button for switching the function mode from the video switcher function mode to the camera controller mode are provided at two locations on the operation panel 130 in the above embodiment, the camera mode switching button may be provided at three or more locations on the operation panel 130.

While the first camera mode switching button 211c and the switcher mode switching button 211s are disposed as switching buttons in the above embodiment, a single switching button may alternatively disposed. The switching button in this case may be a toggle switch by which either of the function modes is always chosen as a matter of logic. When a plurality of toggle switches are disposed on the operation panel 130 in positions corresponding to both hands of the user who operates the toggle switches, the operability of the apparatus operated by the user is advantageously improved.

In the embodiment described above, the video signal processing apparatus 100 has two states, the video switcher function mode and the camera controller mode, and one of the two states transitions to the other in response to the operation of a switching button that works as a trigger. Alternatively, the transition between the states may be prohibited by setting the video signal processing apparatus 100 in advance. That is, the switching between the function modes is disabled even when a switching button is pressed. In this way, the video signal processing apparatus 100 can be used as a dedicated camera controller or video switcher.

The present application contains subject matter related to that disclosed in Japanese Priority Patent Application JP 2008-283630 filed in the Japan Patent Office on Nov. 4, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A video signal processing apparatus comprising:
an input section to which a video signal outputted from a camera the operation of which is controllable or a video signal outputted from an apparatus the operation of which is not controllable;
a first operation section to which a video switcher function is assigned, the video switcher function setting the order in which the video signals are put on the air;
a second operation section to which a camera controller function is assigned, the camera controller function controlling the operation of the camera;
a function mode switching section choosing a first function mode to which the video switcher function is assigned or a second function mode to which the camera controller function is assigned;
a third operation section performing a predetermined process on any of the video signals in the first function mode, whereas controlling the operation of the camera in the second function mode; and
an output section outputting any of the video signals to a display device displaying an image or outputting a control signal controlling the operation of the camera to the camera.

2. The video signal processing apparatus according to claim 1,
wherein the third operation section includes a plurality of operation buttons labeled with respective numbers, and
the output section outputs the video signal corresponding to the number assigned to the operated one of the switching buttons in the first function mode, whereas outputting the video signal inputted from the camera corresponding to the number assigned to the operated one of the switching buttons in the second function mode.

3. The video signal processing apparatus according to claim 2, further comprising
an operation panel on which the first to third operation sections are disposed and the function mode switching section is disposed at a plurality of locations.

4. The video signal processing apparatus according to claim 2,
wherein the third operation section further includes a joy stick instructing the camera to perform any of pan, tilt, and zoom operations, and
the function mode switching section is disposed in an area spaced apart from the center of the shaft of the joy stick at least by 30 mm but within 100 mm from the center.

5. The video signal processing apparatus according to claim 1,
wherein the first operation section includes
a first video selector selecting a first video signal output to be put on the air from the video signals, and
a second video selector selecting a second video signal output to be put on the air after the first video signal.

6. The video signal processing apparatus according to claim 1, further comprising
a display section showing that the current function mode is the first or second function mode.
